(19) United States
(12) Patent Application Publication
(10) Pub. No.: US 2005/0060578 A1
(43) Pub. Date: Mar. 17, 2005

(54) Method of and system for authentication downloading

(75) Inventor: Xin Xue, San Jose, CA (US)

Correspondence Address: HAVERSTOCK & OWENS LLP, 162 NORTH WOLFE ROAD, SUNNYVALE, CA, 94086, US

(73) Assignees: Sony Corporation; Sony Electronics, Inc.

(21) Appl. No.: 10/666,889

(22) Filed: Sep. 17, 2003

(51) Int. Cl. G06F 15/16

(52) U.S. Cl. 713/201; 709/203

(57) ABSTRACT

A method of and system for authorization and authentication downloading utilizes a removable memory having a set of authentication data. A user accesses a server with a handheld electronic device via a wireless Internet connection. The removable memory includes the set of authentication data. The handheld electronic device includes an interface to connect to the Internet when the removable memory is inserted into the handheld electronic device and a connection is formed with a server, using the set of authentication data, the server is able to authenticate the removable memory automatically without the user interfacing personally with the server. The server authenticates downloading to the removable memory in the handheld electronic device by reading the set of authentication data on the removable memory, and downloading the desired content to the removable memory.

### FIELD OF INVENTION

The present invention relates to the field of authentication downloading. More particularly, the present invention relates to the field of authentication downloading using portable memory devices.

### BACKGROUND

The proliferation of handheld electronic devices places a new importance on the ability of a user to download content files such as, but not limited to music, movie or data files from servers via the Internet to the handheld electronic device. Oftentimes, the servers providing the content require authentication from a user requesting that content in order to confirm that the user is authorized to download the requested content. One example of authentication downloading would be a server offering downloadable music files requiring a user to be a paying member before that user is authenticated to download files. Authentication can be time consuming and inconvenient, as the user is usually required to enter a host of personal information before the authentication is completed.

The proliferation of the handheld electronic device has also caused an increased use in removable memory in conjunction with the handheld electronic device. The stored content is easily removable and able to be used on other handheld electronic devices. Current systems usually include a personal computer from which the user interfaces with the server to authenticate the user before content downloading takes place. The downloaded content is then transferred to the handheld electronic device with a synchronization procedure, wherein only then the content is stored in the removable memory. No current systems include a method of authentication downloading that does not include a user interface to effectuate authentication.

### SUMMARY

A method of and system for authorization and authentication downloading utilizes a removable memory having a set of authentication data. A user accesses a server with a handheld electronic device via a wireless Internet connection. The removable memory includes the set of authentication data. The handheld electronic device includes an interface to connect to the Internet when the removable memory is inserted into the handheld electronic device and a connection is formed with a server, using the set of authentication data, the server is able to authenticate the removable memory automatically without the user interfacing personally with the server. The server authenticates downloading to the removable memory in the handheld electronic device by reading the set of authentication data on the removable memory, and downloading the desired content to the removable memory.

In one aspect, a method of downloading content from a server to an electronic device comprises storing authentication data on a removable memory, wherein the authentication data includes a predetermined level of content access, accessing the server with the electronic device, authenticating the removable memory by reading the authentication data from the removable memory and downloading the content from the server to the removable memory according to the predetermined level of content access.

In another aspect, a system for downloading content from a server to an electronic device comprises means for storing authentication data on a removable memory, wherein the authentication data includes a predetermined level of content access, means for receiving the removable memory in the electronic device, means for accessing the server with the electronic device, means for authenticating the removable memory by reading the authentication data from the removable memory and means for downloading the content from the server to the removable memory according to the predetermined level of content access.

In another aspect, a system for downloading content comprises a removable memory, the removable memory including authentication data, the authentication data including a predetermined level of content access, an electronic device configured to receive the removable memory and a server, wherein when the electronic device accesses the server, the removable memory is authenticated by reading the authentication data from the removable memory, and further wherein once authenticated, content according to the predetermined level of content access is downloaded from the server to the electronic device.

In another aspect, an electronic device for downloading comprises a memory slot configured to receive a removable memory, wherein the removable memory includes authentication data, the authentication data including a predetermined level of content access and a communications interface configured for coupling to a server, wherein when the electronic device accesses the server through the communications interface, the removable memory is authenticated by reading the authentication data from the removable memory, further wherein content according to the predetermined level of content access is downloaded.

In yet another aspect, a removable memory for downloading comprises authentication data, the authentication data including a predetermined level of content access and a communications interface configured for coupling to a server, wherein when an electronic device accesses the server through the communications interface, the removable memory is authenticated by reading the authentication data from the removable memory, further wherein the electronic device includes a memory slot configured to receive the removable memory, and further wherein content according to the predetermined level of content access is downloaded.

### BRIEF DESCRIPTION OF THE DRAWINGS

FIG. 1 illustrates a graphical representation of an apparatus according to an embodiment.

FIG. 2 illustrates a graphical representation of an authentication system.

FIG. 3 illustrates a block diagram of the authentication system.

FIG. 4 illustrates a flow chart of an authentication method.

### DETAILED DESCRIPTION

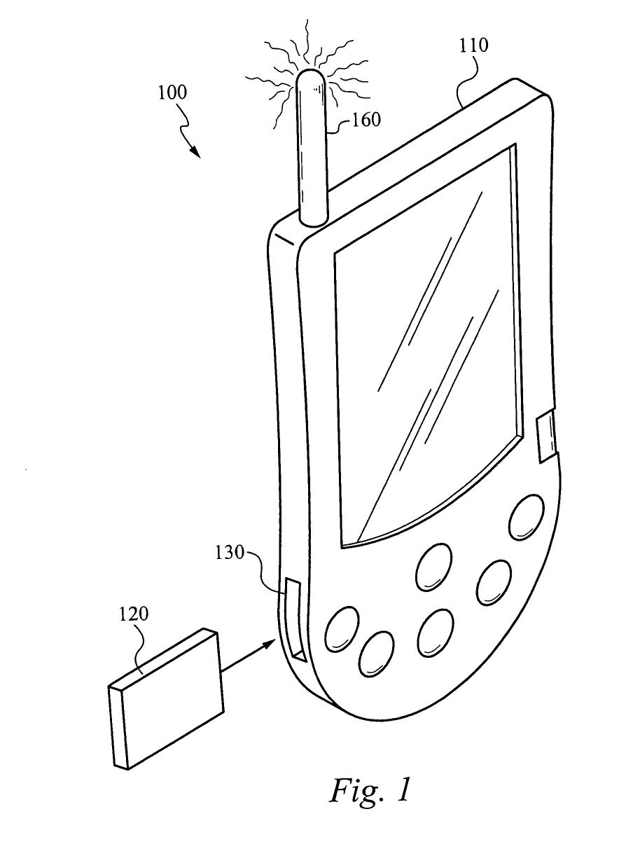

A method of and system for authentication downloading utilizes a handheld electronic device having a removable memory. Referring to FIG. 1, the authentication system 100 is depicted. The authentication system 100 includes an electronic device 110 and removable memory 120. A personal digital assistant (PDA) is depicted in FIG. 1 as the electronic device 110. While a PDA is depicted here in this embodiment, alternative embodiments utilize other electronic devices 110 capable of housing the removable memory 120 and accessing a server through the Internet using either a wired or wireless connection, including but not limited to, cable, DSL and satellite. The wireless capabilities 160 include a wireless connection to the Internet. The use of such wireless capabilities 160 in this embodiment depends on the compatibility of such wireless capabilities 160 with the electronic device 110. In another embodiment, the electronic device 110 communicates using a wired connection through a conduit and/or a PC. Additionally, an embodiment includes the removable memory 120 as a Memory Stick® device such as those developed and sold by Sony Corporation. The use of such removable memory 120 in this embodiment depends on the compatibility of such removable memory 120 with the electronic device 110. In other embodiments, the removable memory 120 is any appropriately configured removable memory, including semiconductor memory such as a flash memory array.

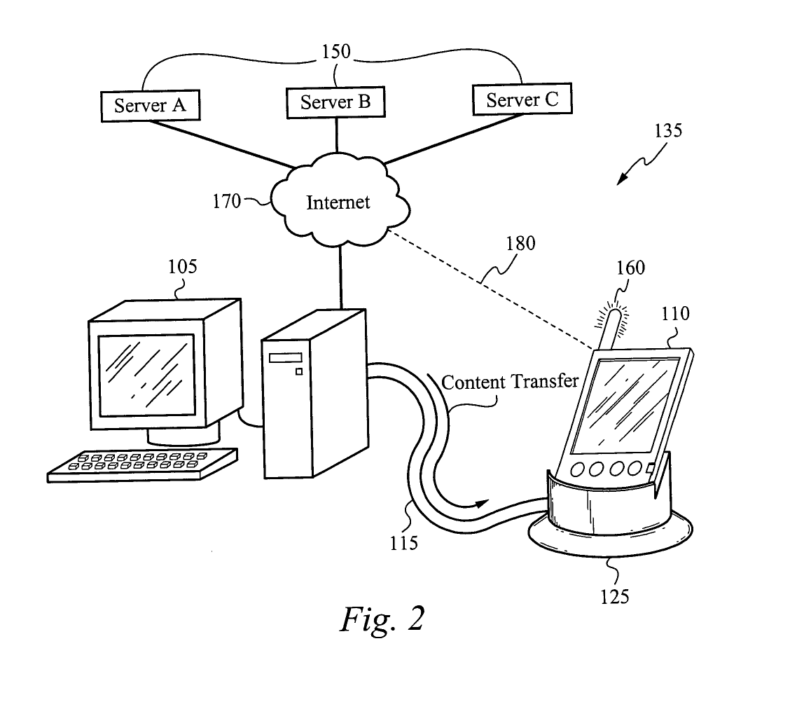

Still referring to FIG. 1, the electronic device 110 of the authentication system 100 receives the removable memory 120 in a memory slot 130. A set of authentication data is stored electronically on the removable memory 120, and when the removable memory is inserted into the memory slot 130, the set of authentication data is available to authenticate the removable memory 120 to download content from a server 150 (FIG. 2), wherein the server 150 (FIG. 2) is accessed by utilizing the wireless capabilities 160 of the electronic device 110 or through a wired connection to the Internet 170 (FIG. 2). The operation of the authentication system 100 is discussed in greater detail later in this document.

FIG. 2 depicts an exemplary authentication system 135 of an embodiment. In FIG. 2, an electronic device 110 in a hotsync cradle 125, is coupled to a personal computer (PC) 105 by a conduit 115. The hotsync cradle 125 receives the electronic device 110 and provides an interface through the conduit 115 to the PC 105 for content transfer. In systems such as that depicted in FIG. 2, when a user accesses a server 150, the user does so through the Internet 170 and using a PC 105 as an interface. When a user wishes to download content from the server 150 for use on an electronic device 110, the user first must be authenticated by the server 150 before being allowed to download content. Authentication such as this usually includes the user providing personal information to the server as well as credit card information to pay for the downloadable content. After authentication, the content is downloaded to the PC 105, before a synchronization method allows the content to be transferred through a conduit 115 to the electronic device 110. In these systems, content downloaded from a server 150 is not saved in the removable memory until all of the afore-mentioned steps have been completed. The authentication system 135 of this embodiment includes a system and method that allows the authentication downloading to occur through the removable memory 120, rather than through a user interface.

Still referring to FIG. 2, an embodiment includes an electronic device 110 having wireless capabilities 160. The authentication system 135 utilizes a wireless connection 180 between the electronic device 110 having wireless capabilities 160 and the Internet 170. Additional embodiments utilize the conduit 115 and the PC 105 to access the Internet 170, and ultimately the server 150. By accessing the Internet 170, the electronic device 110 has access to any servers 150 with downloadable content. It should be noted that a wireless connection 180 to the Internet 170 is not necessary if the servers 150 are accessible through a wired connection such as the conduit 115 and PC 105, a wireless local or wide area network (LAN or WAN), or alternatively a LAN or WAN in which the electronic device 110 is wired to the servers 150. It should also be noted that while it is not shown in FIG. 2, the removable memory (FIG. 1) is inserted in the memory slot 130 (FIG. 1) of the electronic device 110, but is not shown in FIG. 2 for ease of illustration.

Still referring to FIG. 2, upon the server 150 being accessed through the Internet 170, to the electronic device 110, the server 150 is configured to read the contents of the removable memory 120 that is currently in the memory slot 130 of the electronic device 110. This is how authentication is achieved without user interface. In an embodiment, the removable memory 120 includes a set of authentication data that tells the server 150 what content the user is authorized to download to the electronic device 110, and thus the removable memory 120. In an embodiment, a server operator issues removable memory 120 for sale to users, such removable memory 120 having this pre-assigned set of authentication data tailored to the needs of the user and the authentication level desired by the user. The user will then insert the removable memory 120 corresponding to the server 150 having the desired content for download. In this embodiment, free content results in a free removable memory 120, while content normally sold for a fee results in a fee for the removable memory 120.

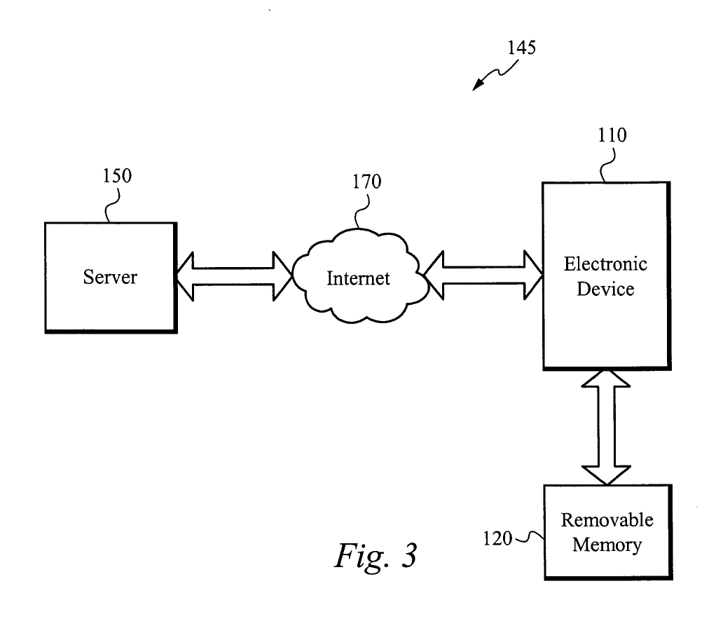

Referring now to FIG. 3, the set of authentication data is implemented on the removable memory 120 in a number of ways. In one embodiment, the set of authentication data will include a subscription identification number. The subscription identification number is coded inside the removable memory 120 by the server operator, such that only the server operator knows how to decode the subscription identification number. From this subscription identification number, the server 150 identifies what content the user is authorized to download from the server, or alternatively what content to automatically send to the electronic device.

In another embodiment, when the removable memory 120 is a Memory Stick ®, a chip ID that is unique to every Memory Stick ® is installed on every removable memory 120. In this case, this chip ID is used by the server operator as the set of authentication data, such that the chip ID will designate the level of content available to the user. In another embodiment, the set of authentication data of the removable memory 120 is time stamped such that the set of authentication data is used to access the content only for a predetermined amount of time. After the expiration of this time period, the set of authentication data will no longer be valid to access this content.

Still referring to FIG. 3, the system 145 of this embodiment includes a removable memory 120 coupled to the electronic device 110, such that the electronic device 110 maintains a connection to the Internet 170. In this embodiment, the connection between the electronic device 110 and the Internet 170 is through a wireless connection or a wired connection through a conduit and/or a PC. A server 150 is accessed through the Internet 170, such that the server is able to read a set of authentication data from the removable memory 120. The set of authentication data is used to determine what content is available for download from the server 150 to the electronic device 110 and removable memory 120 through the wireless connection 180 to the Internet 170.

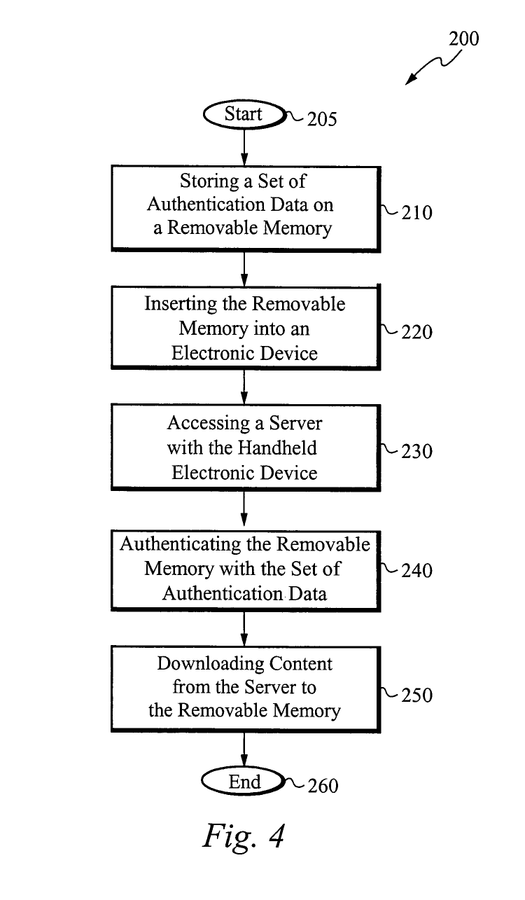

Referring now to FIG. 4 and FIG. 2 simultaneously, an embodiment includes an authentication method 200. The method starts at the step 205. At the step 210, a set of authentication data is stored on a removable memory 120 (FIG. 1). The set of authentication data is data that is coded and read by the provider of the removable memory device 120. In this embodiment, the removable memory 120 is a semiconductor memory, including but not limited to a Memory Stick® device or other flash memory array. Alternatively, any removable memory 120 that is compatible with a handheld electronic device 110 is used. At the step 220, the removable memory 120 with the set of authentication data is inserted into a handheld electronic device 110 by a user. In one embodiment, the handheld electronic device 110 is a personal digital assistant (PDA). Alternatively, any handheld device 110 with Internet 170 access that is capable of receiving a removable memory 120 is implemented.

Still referring to FIG. 4 and FIG. 2, at the step 230 a server 150 is accessed with the handheld electronic device 110, connecting to such a server 150 through the Internet 170. The connection is formed with the server 150 to access, and if desired, download content from the server 150. At the step 240, the removable memory 120 is authenticated as the server 150 reads the set of authentication data from the removable memory 120 in the handheld electronic device 110. The set of authentication data will determine how much, if any of the content on the server 150 is available to the user to download to the removable memory 120. The set of authentication data is coded by the server operator and each set of authentication data allows a predetermined amount and type of content to be downloaded from the server 150. After the authentication is completed at the step 240, content from the server 150 is then downloaded to the removable memory 120 at the step 250 before the method ends at the step 260. At the step 250, only content to the level of the authentication of the removable memory 120 at the step 240 is downloaded at the step 250.

In operation, referring to FIGS. 1-3 simultaneously, the manufacturer of the removable memory 120 stores authentication data on the removable memory 120 before the removable memory is sold or provided to a user. The authentication data includes a predetermined level of content access for which the user (or purchaser) of the removable memory 120 is able to download from a server 150. Oftentimes, the manufacturer of the removable memory 120 and the server operator are the same entity. In one embodiment, a manufacturer of removable memory 120 manufactures removable memory 120 for other server operators. In either case, a user purchases or receives the removable memory 120 based on the amount and type of content the user wishes to download from a particular server. The price of the removable memory depends on this particular amount and type of content the removable memory allows the user to download.

Still referring to FIGS. 1-3, the set of authentication data is implemented on the removable memory 120 in a number of ways. In one embodiment, the manufacturer stores the authentication data on the removable memory including a subscription identification number. The subscription identification number is coded such that only the manufacturer or the server operator knows how to decode the subscription identification number. From this subscription identification number, the server 150 determines what content the user is authorized to download from the server, or alternatively what content to automatically send to the electronic device.

In the case where the removable memory 120 is a Memory Stick®, a chip ID that is unique to every Memory Stick® is installed on every removable memory 120. In this case, this chip ID is used by the server 150 operator as the set of authentication data, such that the chip ID designates the level of content available to the user. In one embodiment, the manufacturer or server 150 operator monitors or limits the downloading of content by time stamping the authentication data such that the set of authentication data is used to access the content only for a predetermined amount of time. After the expiration of this time period, the set of authentication data is no longer valid to access this content.

After purchasing a removable memory 120 authorizing the user to access the desired content from the server 150, the user inserts the removable memory 120 into the memory slot 130 of an electronic device 110. In one embodiment this electronic device is a PDA. The user then is able to access the server 150 from which the content will be downloaded by either a wired connection, perhaps through the hotsync conduit 115 and the PC 105, or through a wireless Internet connection 180. In one embodiment, the electronic device 110 accesses the server through any appropriate wired or wireless connection. Upon accessing the server 150 through the electronic device 110, the server 150 authenticates the removable memory 120 with the authentication data and determines the level and amount of access for which the user is authorized, thus allowing the user to download the desired content from the server 150 through the connection to the electronic device 110.

The described embodiments include a method of and system for authentication downloading that provide a fast and efficient means to authenticate a removable memory device without exposing the user to an oftentimes long and inconvenient authentication process that requires the user not only to enter a host of personal information, but usually requires the user to also enter credit card or other payment information, thus creating a security issue. Furthermore, the authentication system is advantageous in that it not only eliminates the step of authenticating, but also eliminates a synchronization procedure after downloading content to a PC.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill in the art that while the preferred embodiment of the present invention is used with PDAs, the present invention can also be implemented on any other appropriate electronic device and/or with any appropriate type of removable memory.

1. A method of downloading content from a server to an electronic device, comprising:
storing authentication data on a removable memory, wherein the authentication data includes a predetermined level of content access;
accessing the server with the electronic device;
authenticating the removable memory by reading the authentication data from the removable memory; and
downloading the content from the server to the removable memory according to the predetermined level of content access.

2. The method according to claim 1 wherein the authenticating is performed by the server.

3. The method according to claim 1 wherein the removable memory is a semiconductor memory.

4. The method according to claim 1 further comprising time stamping the authentication data, such that the predetermined level of content access is available for a predetermined amount of time.

5. The method according to claim 1 wherein the server is accessed through a wired internet connection, further wherein the wired internet connection includes a conduit and a personal computer.

6. The method according to claim 1 wherein the server is accessed through a wireless connection.

7. The method according to claim 6 wherein the wireless connection includes an internet connection.

8. The method according to claim 6 wherein the wireless connection includes a local area network.

9. The method according to claim 6 wherein the wireless connection includes a wide area network.

10. A system for downloading content from a server to an electronic device, comprising:
means for storing authentication data on a removable memory, wherein the authentication data includes a predetermined level of content access;
means for receiving the removable memory in the electronic device;
means for accessing the server with the electronic device;
means for authenticating the removable memory by reading the authentication data from the removable memory; and
means for downloading the content from the server to the removable memory according to the predetermined level of content access.

11. The system according to claim 10 wherein the means for authenticating is included within the server.

12. The system according to claim 10 wherein the removable memory is a semiconductor memory.

13. The system according to claim 10 wherein the authentication data also includes a time stamp, such that the predetermined level of content access is available for a predetermined amount of time.

14. The system according to claim 10 wherein the means for accessing accesses the server through a wired internet connection, further wherein the wired internet connection includes a conduit and a personal computer.

15. The system according to claim 10 wherein the means for accessing accesses the server through a wireless connection.

16. The system according to claim 15 wherein the wireless connection includes an internet connection.

17. The system according to claim 15 wherein the wireless connection includes a local area network.

18. The system according to claim 15 wherein the wireless connection includes a wide area network.

19. A system for downloading content, comprising:
a removable memory, the removable memory including authentication data, the authentication data including a predetermined level of content access;
an electronic device configured to receive the removable memory; and
a server, wherein when the electronic device accesses the server, the removable memory is authenticated by reading the authentication data from the removable memory, and further
wherein once authenticated, content according to the predetermined level of content access is downloaded from the server to the electronic device.

20. The system according to claim 19 wherein the server performs the authentication of the removable memory.

21. The system according to claim 19 wherein the removable memory is a semiconductor memory.

22. The system according to claim 19 wherein the authentication data is time stamped, such that the predetermined level of content access is available for a predetermined amount of time.

23. The system according to claim 19 wherein the server is accessed through a wired internet connection, further wherein the wired internet connection includes a conduit and a personal computer.

24. The system according to claim 19 wherein the server is accessed through a wireless connection.

25. The system according to claim 24 wherein the wireless connection includes an internet connection.

26. The system according to claim 24 wherein the wireless connection includes a local area network.

27. The system according to claim 24 wherein the wireless connection includes a wide area network.

28. An electronic device for downloading, comprising:
a memory slot configured to receive a removable memory, wherein the removable memory includes authentication data, the authentication data including a predetermined level of content access; and
a communications interface configured for coupling to a server, wherein when the electronic device accesses the server through the communications interface, the removable memory is authenticated by reading the authentication data from the removable memory,
further wherein content according to the predetermined level of content access is downloaded.

29. The electronic device according to claim 28 wherein the server performs the authentication of the removable memory.

30. The electronic device according to claim 28 wherein the removable memory is a semiconductor memory.

31. The electronic device according to claim 28 wherein the authentication data is time stamped, such that the predetermined level of content access is available for a predetermined amount of time.

32. The electronic device according to claim 28 wherein the communications interface is a wired internet connection, further wherein the wired internet connection includes a conduit and a personal computer.

33. The electronic device according to claim 28 wherein the communications interface is a wireless connection, the wireless connection including an internet connection.

34. The electronic device according to claim 33 wherein the wireless connection includes a local area network.

35. The electronic device according to claim 33 wherein the wireless connection includes a wide area network.

36. A removable memory for downloading, comprising:
authentication data, the authentication data including a predetermined level of content access; and
a communications interface configured for coupling to a server, wherein when an electronic device accesses the server through the communications interface, the removable memory is authenticated by reading the authentication data from the removable memory, further wherein the electronic device includes a memory slot configured to receive the removable memory, and further
wherein content according to the predetermined level of content access is downloaded.

37. The removable memory according to claim 36 wherein the server performs the authentication of the removable memory.

38. The removable memory according to claim 36 wherein the removable memory is a semiconductor memory.

39. The removable memory according to claim 36 wherein the authentication data is time stamped, such that the predetermined level of content access is available for a predetermined amount of time.

40. The removable memory according to claim 36 wherein the communications interface is a wired internet connection, further wherein the wired internet connection includes a conduit and a personal computer.

41. The removable memory according to claim 36 wherein the communications interface is a wireless connection, the wireless connection including an internet connection.

42. The removable memory according to claim 41 wherein the wireless connection includes a local area network.

43. The removable memory according to claim 41 wherein the wireless connection includes a wide area network.
